(19) United States
(12) Patent Application Publication
(10) Pub. No.: US 2011/0055740 A1
(43) Pub. Date: Mar. 3, 2011

(54) DEFINING AND SHARING DISPLAY SPACE TEMPLATES

(75) Inventors: Clayton Palmer Coleman, Durham, NC (US); Patrick Gabriel McGowan, Chapel Hill, NC (US); Jeremy Gray Perry, Cary, NC (US); Michael C. Wanderski, Durham, NC (US)

(73) Assignee: International Business Machines Corporation, Armonk, NY (US)

(21) Appl. No.: 12/549,637

(22) Filed: Aug. 28, 2009

(51) Int. Cl. G06F 3/048

(52) U.S. Cl. 715/765

(57) ABSTRACT

A computer-implemented method of customizing a user interface comprises receiving, by the computer, a user selection of a portion of content displayed by a user interface, and limiting, by the computer, future loading or updating of elements corresponding to the selected portion. Limiting future loading or updating of elements corresponding to the selected portion may comprise preventing future loading or updating of elements corresponding to the selected portion. Alternatively, limiting future loading or updating of elements corresponding to the selected portion may comprise reducing a frequency of future updating of elements corresponding to the selected portion.

### BACKGROUND

The present invention relates to user interfaces, and more particularly to customizing user interfaces.

Today, statically defined web-based user interfaces may provide collapsible sections to hide or show specific areas of the page. This is even more prominent on user interfaces that aggregate content from many disparate sources (e.g. a portal page, a mash-up application, etc.). Applications may provide areas of a page where users can either hide or show the area (e.g. as a collapsible section) and have that stored as a personal preference for a session or lifetime of the application. The areas of the page that are collapsible however, are determined by the application (or aggregator in cases of portal, mashup, etc.) which provide a static “template” of how the application user interface should behave. What and where content is shown on a page however may be a very personal and subjective opinion. One user might have interest in one part of an application (and thus always want that shown), while another person might find another area of the application more important. Additionally, the way content is displayed on the page is sometimes determined based on how the data that populates that content is requesting information from the server (e.g. a data feed). This is known in Ajax-based interfaces that load the initial “template” and then make background requests to populate each area of the interface. These may be data decisions on how the page should behave, instead of a more appropriate personal decision made by the user of the application interface.

### BRIEF SUMMARY

In one embodiment of the invention, a computer-implemented method of customizing a user interface comprises receiving, by the computer, a user selection of a portion of content displayed by a user interface, and limiting, by the computer, future loading or updating of elements corresponding to the selected portion. Limiting future loading or updating of elements corresponding to the selected portion may comprise preventing future loading or updating of elements corresponding to the selected portion. Alternatively, limiting future loading or updating of elements corresponding to the selected portion may comprise reducing a frequency of future updating of elements corresponding to the selected portion.

The method may further comprise customizing, by the computer, a future display of the selected portion by rendering the selected portion fully hidden, partially visible, or visible.

The method may further comprise receiving, by the computer, a user selection of a display template. The future display of the selected portion is then customized based on the selected display template.

The method may further comprise storing, by the computer, the portion selection and the display template selection. The future display of the selected portion is then customized based on the stored portion selection and the stored display template selection.

In addition to the method of customizing a user interface, as described above, other aspects of the present invention are directed to corresponding systems and computer program products for customizing a user interface.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1 and 2 are screen shots illustrating the operation of customizing a user interface according to various aspects of the present invention;

FIG. 3 is a schematic block diagram of a computer network in which embodiments of the present invention may operate; and

FIG. 4 is a schematic block diagram of a computer in the network of FIG. 3.

### DETAILED DESCRIPTION

Embodiments of the invention provide the ability to customize the display of content (such as a Web page) which is displayed on a user interface, and to change the loading and updating operations of portions of the content. Based on user selection, the user is able to dynamically control the display of portions of the content, providing personal control over the real estate and attention management based on the user's preferences (as opposed to the current fixed display determined by the application developer). To accomplish this, a user would interact with an application normally, such as by using a Web browser on a client computer to access a Web server and to download one or more Web pages. The Web pages may comprise a number of distinct HTML (Hypertext Markup Language) elements, such as headers, lists, list elements, and the like, that may each contain information, data, graphics, etc. In embodiments of the invention, the user is able to select or highlight areas of the page that the user would like to make dynamically display-able. This user selection can be done, for example, by highlighting DOM (document object model) artifacts (which may be accomplished by hovering over the DOM to be selected), selecting text or tables in the page (such as by using a mouse or other pointing device), or by other by other means such as drawing a square over the area to be identified (such as by using a mouse or other pointing device).

Once the desired content portion is selected, a plurality of display templates may be presented for the user to select. The display templates define pre-configured options for customizing the display of the selected content portion. The display templates may be created and distributed by any interested parties, such as a Web browser developer, a Website operator, or a user. User-created display templates may be stored in local memory or remotely on a server, and may be shared with other users. Example types of different display options that may be provided by display templates include a traditional collapsible section, a dynamic slider, and an accordion-type display. Other display templates could cause the selected content portion to be, for example, always hidden or always visible. A display template is selected by the user and applied to the selected portion. In a case in which the display template causes the selected content portion to be hidden, the surrounding page artifacts may move into place to fill any open areas.

Most software applications today, especially Web applications that employ Ajax (asynchronous JavaScript and XML)-based techniques, populate portions of the page with content requested in the background. The performance characteristics of each request are unique, some of which are fast, but others require additional algorithms, queries, etc. that add additional latency to the request, as well as consume resources on the server. Further exacerbating this problem is that some of the content may be configured to periodically update/reload from the server to ensure new/updated information is visible to the user. Thus, the increased latency is experienced both during the initial loading of the content and during any future updates/reloads of the content. Embodiments of the invention can improve this situation by limiting or preventing the loading/updating of selected content. This may, although not necessarily, be done by limiting or preventing the loading/updating of content that is hidden (by selection of an appropriate template). In one embodiment of the invention, a selected content portion may be configured with a template to be user-selectably visible or hidden. In such an embodiment, the selected content would not load/update when the selected content is hidden by the user but would load/update when the selected content is made visible by the user. Optionally, with the selection of an appropriate display template, the selected content may remain visible but would have limited/no updating. In another embodiment, a display template may be selected which reduces the frequency at which a selected content portion updates. For example, a selected content portion may be configured by the developer to routinely update every five minutes. Embodiments of the invention may, instead, limit the update of the selected portion to at a user-configurable frequency (e.g., once every two hours) or upon demand by the user.

The ability to dynamically select areas of the page and make them either load/update or not load/update based on user selection can help save resources by not requesting the page to be populated in areas that are not shown. This can help a user (instead of an application developer) determine what tolerance the use has for loading and waiting on a page to render. For example, if typically the area of the page that shows a list of “favorites” takes a long time to load and is shown on every page, a user could dynamically select that area and apply a collapsible template to hide that area of the page (and prevent the invocations that caused latency), while still maintaining the persistence of the “favorites” area in the user interface. This can allow users to optimize the performance characteristics of an application based on their personal preference and tolerance.

In addition to letting a user define the portion(s) of the content to affect, embodiments of the invention can help with “suggestion-based selecting” of areas of the page to better align with the loading characteristics of the page. For example, if there is an area of the page that is loaded with an Ajax request to the server, and the user has highlighted only 90% of that area to make collapsible, the system can “suggest” (e.g., additionally highlight) the other 10% of the area that is loaded with the Ajax request and inform the user of the potential benefit that this additional suggested selection will provide (e.g., a “20% savings in load time”). This suggestive highlighting can work where the user-selected content portion area crosses natural data collection boundaries (e.g., background requests to populate a page) and can then suggest larger or smaller selection areas to help optimize the performance (and reduce requests made) of the application.

The configuration that a user defines can be persisted client side (or server side) as a preference that can be applied across application sessions. Additionally, embodiments of the invention can provide for a directory of “templates” that can be shared amongst users, for example in a similar domain or group. Thus for example, if a person creates an optimized display configuration for performance, that can be posted and shared with persons wanting a similar performance conscious application experience. Additionally, embodiments of the invention can dynamically highlight parts of the page (in real time) that have been previously selected by other users, by showing indicators that can be selected and used. Further, embodiments of the invention could leverage automatic averaging/counting to recommend which sections to use. For example, a message could be displayed to a user that “80% of people collapse this section, would you like to do the same?”. Embodiments of the invention may apply aspect-oriented techniques to determine what areas (other than the user-selected area(s)) to which the selected template could be applied. For example, embodiments of the invention might identify that the user selected a content portion that contained an HTML H3 header. In such an example, the user could be presented with an option to apply a selected template to all H3 headers.

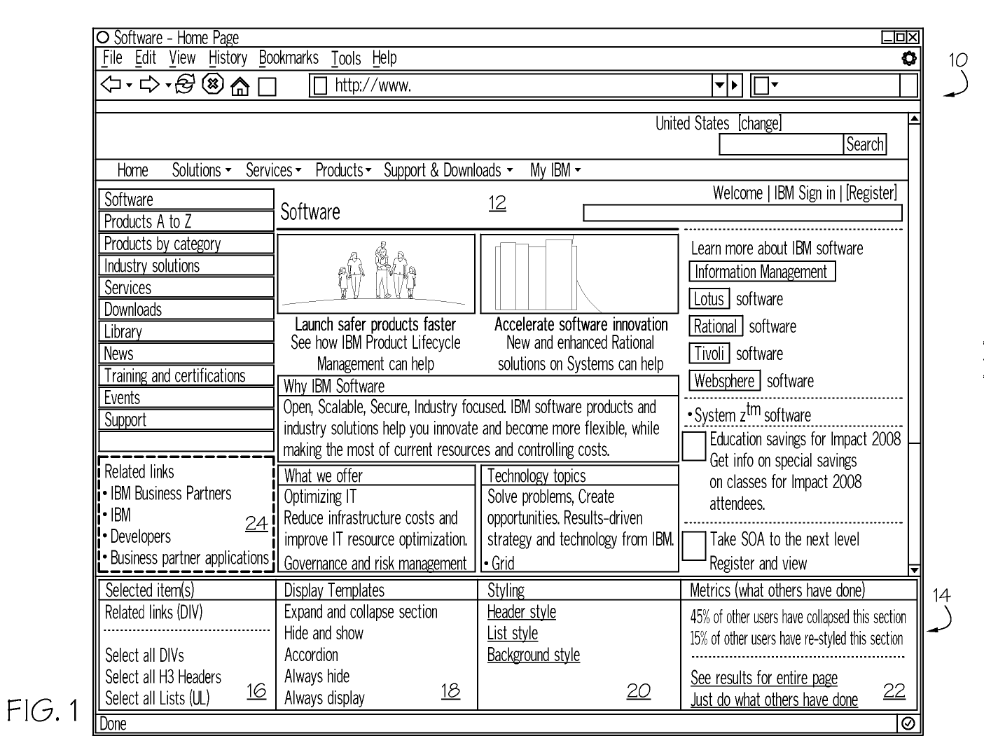

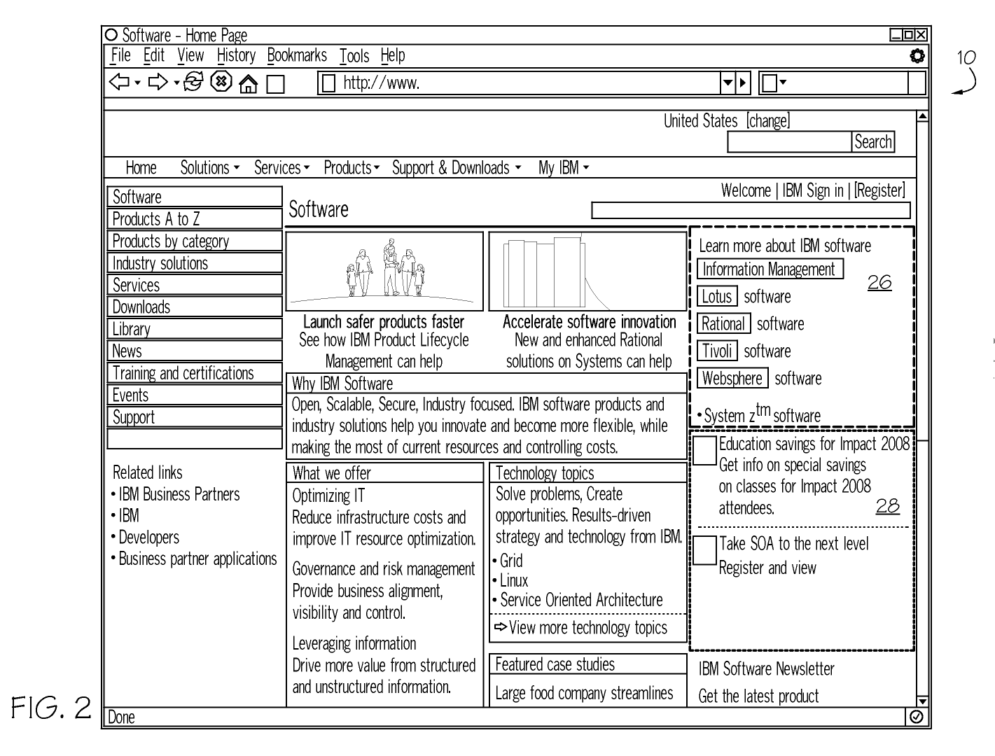

Referring now to the drawings and particularly to FIGS. 1 and 2, screen shots illustrating the operation of customizing a user interface according to various aspects of the present invention. The screen shot 10 of FIG. 1 illustrates Web page content 12 being viewed in a Web browser. In accordance with embodiments of the invention, a customization menu 14 may be presented to the user. FIG. 1 is intended to illustrate a menu that may, for example, pop up from the bottom of the browser window, however the customization menu may be presented to the user in any desired manner. The customization menu 14 may comprise sub-menus 16, 18, 20, and 22, the function of which will be described below.

In one example, a user may wish to hide the “Related links” portion of the content and therefore selects that portion, such as by using a mouse to draw a rectangle around that portion. In FIG. 1, the user's selection of this portion of content is illustrated by dashed line box 24. In accordance with embodiments of the invention, the invention determines that the selected portion contains one or more HTML DIV tags, one or more HTML headers (H3 headers in this example), and one or more HTML lists. Thus, in sub-menu 16, the user is presented with the option of selecting all DIV tags, all H3 headers, and/or all lists. If the user selects one of these options, all areas of the page that contain the selected element(s) will be highlighted. Regardless of whether the user selects one of the options in sub-menu 16, the user may then select one of the display templates from sub-menu 18 to be applied to the selected content. Sub-menu 18 illustrates five display templates, although a greater or lesser number of templates (and different templates) may be presented to the user. As discussed above, the selected display template customizes the display and loading/updating characteristics of the selected content portion.

Sub-menu 20 presents different styling options to the user. This menu displays and enables the user to select different options for “style” to be applied to a section (for example, changing the font and color related characteristics on different parts of the UI).

Sub-menu 22 presents information regarding what other users have done in terms of customizing the display of the selected portion. In the illustrated example, the user is informed of that 45% of other users have customized the selected portion to be collapsed. Sub-menu 22 may also give the user the option of seeing how other users have customized other portions of the content (not just the portion selected by this user), or to simply choose to allow the invention to make the same customizations that other users have done (which may be based, for example, on what a majority of users have done).

FIG. 2 illustrates the operation of the “suggestion-based selecting” described above. In the example illustrated in FIG. 2, a user has selected content portion 26 (illustrated by the dashed line) to customize. The invention may determine that selecting an additional portion 28 (illustrated by the dotted line) would provide further significant improvements to the loading/updating of the content beyond that which would result from the user's selection. For example, the invention may determine that selecting suggested area 28 would cause the remaining content to load/update 60% faster. The invention may display a notice to the user of such possible improvement (such as in a pop-up alert) and provide a way of enabling the user to accept or decline the suggestion (such as by providing “Accept” and “Decline” buttons in the pop-up alert.

One technique for implementing embodiments of the invention is to leverage the fact new user interfaces may be generated using interpreted XML-based definitions. For example, XHTML for web clients, XAML for native Windows desktop applications, XUL for Mozilla browser extensions, etc. All of these XML based user interface definitions inherently are well structured, and thus can be introspected and manipulated using techniques such as a DOM object model, or a SAX (Simple API for XML) parser. In addition, user interfaces can be built using a variety of AJAX and REST (Representational State Transfer)-based techniques, which allow on-demand interpretation, generation, and caching of the user interface on the client. As part of this process, it is possible to insert a proxying component to capture communication between the client and server, and capture real-time data to either make modifications to the current user interface, or contribute back to a central repository to help inform other clients of pro-active changes they can make. So bringing together these concepts with a variety of situational feedback, it is possible to fully manipulate a user interface based on a variety of real-time, or historical user feedback, as described herein, even after a product has been shipped without having to make costly code changes. So for example, if it is determined that a particular user interface call (using AJAX) has a particular latency or bottleneck associated with it due to particular conditions (e.g. large request being made to a geo far from the server), it is possible to automatically take corrective action in the user interface to minimize this request (parse the XML into a DOM object and manipulate the object to collapse that particular section). The process can also now “call home” and relay this information to the central repository service which will record what calls are being made, what the offending action is, and other situational information like geo, etc. This “calling home” can be done by another on-demand AJAX call to a web service hosted on the server. And now, other clients undergoing a similar pattern can adapt to this historical information if it matches the same (or similar) behavior pattern. It is possible to employ simple pattern matching techniques to determine the likelihood of a similar situation based on matching criteria, and thus manipulate the user interface accordingly as described.

While current software applications may provide the ability for users to configure some aspects of the application, these areas are subjectively selected by designers and application developers and may be a point of contention during application development. It is well known in the art that it is impossible to build a “one solution fits all” in terms of application customization and preferences. Embodiments of the invention can benefit application developers by reducing the amount of time and resources spent trying to build the perfect solution, and instead allow users to determine their own user interface experience. Additionally, embodiments of the invention can provide significant cost reductions in areas of problem management records (PMRs) for example. Software applications may be delivered to the field that afterward are determined to have significant performance issues related to a particular portion of the content (e.g., because of resource-expensive background requests). Often, this requires “fixes” to be delivered to the field (or worse, one-off solutions provided to individual customers). With embodiments of the invention, a software developer could deliver to the field a new display template that could be used to eliminate the performance issues without having to write a single line of code, thereby providing significant cost savings.

While embodiments of the invention are described in detail above in relation to Web-based applications, embodiments of the invention are not only applicable to Web-based applications but could apply to any applications engineered with markup-based interfaces (because of their inherent DOM manipulation and scripting abilities) including rich desktop interfaces defined in emerging standards such as XAML, XUL, XHTML, etc.

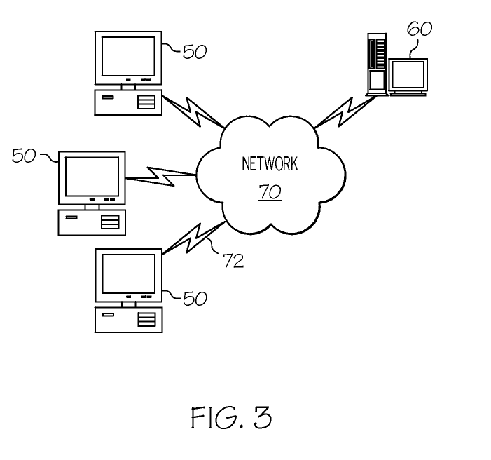

FIG. 3 is a schematic block diagram of a computer network in which embodiments of the present invention may operate. Computers 50 and server 60 provide processing, storage, and input/output devices executing application programs and the like. Computers 50 may be linked over communication link 72 through communications network 70 to each other and to other computing devices, including server 60. Communications network 70 can be part of the Internet, a worldwide collection of computers, networks, and gateways that currently use the TCP/IP suite of protocols to communicate with one another. The Internet provides a backbone of high-speed data communication lines between major nodes or host computers, consisting of thousands of commercial, government, educational, and other computer networks, that route data and messages. However, computers 50 and server 60 may be linked over any suitable communication network. In the system of FIG. 3, computers 50 may be running Web browsers used for accessing and viewing websites, such as may be hosted on server 60. In this arrangement, accessing and viewing websites includes downloading and updating display elements (such as HTML elements) and data from the server 60 to the computers 50.

In addition to the client-server arrangement of FIG. 3, embodiments of the invention may operate in any client-server arrangement or in any networked arrangement in which display elements, data, and/or other information are sent from a source to a recipient. For example, embodiments of the invention may operate in a mobile communications/data architecture (such as a mobile telecommunications network adhering to the International Mobile Telecommunications-2000 (also termed 3G) standards), in which a mobile telecommunications device (e.g., cell/mobile telephone) is the recipient.

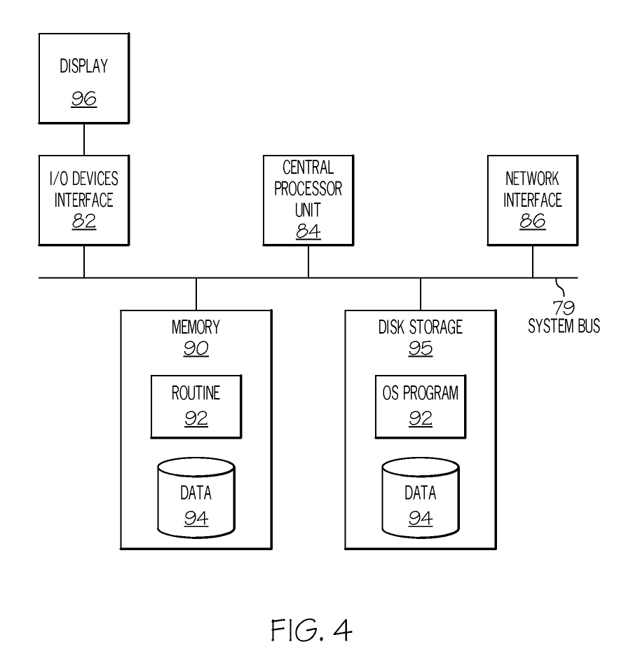

FIG. 4 is a diagram of the internal structure of a computer (e.g., computers 72, 74 or servers 76) in the computer network of FIG. 3. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays 96, printers, speakers, etc.) to the computer. Network interface 86 allows the computer to connect to various other devices attached to a network (e.g., network 70 of FIG. 3). Memory 90 provides volatile storage for computer software instructions used to implement an embodiment of the present invention. Disk storage 95 provides non-volatile storage for computer software instructions and data used to implement an embodiment of the present invention. Central processor unit 84 is also attached to system bus 79 and provides for the execution of computer instructions.

As will be appreciated by one skilled in the art, the present invention may be embodied as a system, computer-implemented method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer-readable medium could even be punch-card, paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain or store the program for use by or in connection with the instruction execution system, apparatus, or device.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for customizing a user interface, the method being implemented by a computer, the method comprising:
receiving, by the computer, a user selection of a portion of content displayed by a user interface; and
limiting future loading or updating of elements corresponding to the selected portion.

2. The method of claim 1, further comprising:
customizing, by the computer, a future display of the selected portion by rendering the selected portion fully hidden, partially visible, or visible.

3. The method of claim 1, further comprising:
receiving, by the computer, a user selection of a display template;
wherein customizing a future display of the selected portion comprises customizing, by the computer, the future display based on the selected display template.

4. The method of claim 3, further comprising:
storing, by the computer, the portion selection and the display template selection;
wherein customizing a future display of the selected portion comprises customizing, by the computer, the future display based on the stored portion selection and the stored display template selection.

5. The method of claim 1, wherein limiting future loading or updating of elements corresponding to the selected portion comprises preventing, by the computer, future loading or updating of elements corresponding to the selected portion.

6. The method of claim 1, wherein limiting future loading or updating of elements corresponding to the selected portion comprises reducing, by the computer, a frequency of future updating of elements corresponding to the selected portion.

7. A computer program product for customizing a user interface, the computer program product comprising at least one computer-readable storage medium having computer-readable program code stored therein, the computer-readable program code comprising:
computer-usable program code for receiving a user selection of a portion of content displayed by a user interface; and
computer-usable program code for limiting future loading or updating of elements corresponding to the selected portion.

8. The computer program product of claim 7, further comprising:
computer-usable program code for customizing a future display of the selected portion by rendering the selected portion fully hidden, partially visible, or visible.

9. The computer program product of claim 7, further comprising:
computer-usable program code for receiving a user selection of a display template;
wherein the computer-usable program code for customizing a future display of the selected portion customizes the future display based on the selected display template.

10. The computer program product of claim 9, further comprising:
computer-usable program code for storing the portion selection and the display template selection;
wherein the computer-usable program code for customizing a future display of the selected portion customizes the future display based on the stored portion selection and the stored display template selection.

11. The computer program product of claim 7, wherein the computer-usable program code for limiting future loading or updating of elements corresponding to the selected portion comprises computer-usable program code for preventing future loading or updating of elements corresponding to the selected portion.

12. The computer program product of claim 7, wherein the computer-usable program code for limiting future loading or updating of elements corresponding to the selected portion comprises computer-usable program code for reducing a frequency of future updating of elements corresponding to the selected portion.

13. A system for customizing a user interface, the system comprising:
a processor configured for receiving a user selection of a portion of content displayed by a user interface further configured for limiting future loading or updating of elements corresponding to the selected portion; and a memory element.

14. The system of claim 13, wherein the processor is further configured for customizing a future display of the selected portion by rendering the selected portion fully hidden, partially visible, or visible.

15. The system of claim 13, wherein the processor is further configured for receiving a user selection of a display template; and
wherein the processor is further configured for customizing a future display of the selected portion based on the selected display template.

16. The system of claim 15, wherein the processor is further configured for storing the portion selection and the display template selection in the memory element; and
wherein the processor is further configured for customizing a future display of the selected portion based on the stored portion selection and the stored display template selection.

17. The system of claim 13, wherein limiting future loading or updating of elements corresponding to the selected portion comprises preventing future loading or updating of elements corresponding to the selected portion.

18. The system of claim 13, wherein limiting future loading or updating of elements corresponding to the selected portion comprises reducing a frequency of future updating of elements corresponding to the selected portion.
